(19) United States
(12) Patent Application Publication
(10) Pub. No.: US 2015/0071105 A1
(43) Pub. Date: Mar. 12, 2015

(54) Method and System for Compensating for Interference Due to Carrier Frequency Offset in an OFDM Communication System

(71) Applicant: The Provost, Fellows, Foundation Scholars, & the other members of Board, of the College of the Holy, Dublin (ID)

(72) Inventor: Arman Farhang, Dublin (IE)

(21) Appl. No.: 14/484,845

(22) Filed: Sep. 12, 2014

Related U.S. Application Data
(60) Provisional application No. 61/876,972, filed on Sep. 12, 2013.

(51) Int. Cl. H04L 25/03; H04L 1/00; H04L 27/26

(52) U.S. Cl. CPC H04L 25/03159; H04L 27/2657; H04L 1/0071; H04L 2025/03414; H04L 2025/03636
USPC 370/252

(57) ABSTRACT

The invention provides a system and method for compensating for interference in a received signal due to carrier frequency offset in an uplink of an Orthogonal frequency division multiple access, OFDMA, communication system which uses interleaved and block interleaved carrier assignment schemes.

### CROSS REFERENCE TO PRIOR APPLICATIONS

This application claims priority to and the benefit of U.S. Provisional Patent Application No. 61/876,972, filed on Sep. 12, 2013, the entire content of which is hereby incorporated by reference.

### FIELD

The present invention is concerned with carrier frequency offset compensation techniques in an uplink OFDMA communication system.

### BACKGROUND

Orthogonal frequency division multiple access (OFDMA) communication systems have been adopted for the uplink of several standards, such as mobile wireless metropolitan area networks (WMANs). OFDMA is the combination of frequency division multiple access (FDMA) protocol and the OFDM technique.

In OFDMA technology, subcarriers are grouped into distinct clusters that are assigned to different users. Different carrier assignment schemes (CAS) may be used for the better utilization of the spectrum. For instance, dynamic assignment of the subcarriers brings to OFDMA systems the ability of dynamic resource management.

Although OFDMA provides robustness against multipath fading channels, it is highly sensitive to synchronization errors in the form of carrier frequency offset (CFO) between the transmitter and the receiver. This is due to the fact that as the received signal at the base station in the uplink of OFDMA based systems contains the signals of all the users that are sending their data streams simultaneously, OFDMA systems experience different carrier frequency offsets due to different users. Inaccurate synchronization destroys the orthogonality between subcarriers, and causes multiple access interference (MAI), inter-symbol interference (ISI) as well as inter-carrier interference (ICI).

The ISI due to timing misalignment of different users' signals can be obviated by the choice of adequately long cyclic prefix (CP) in each OFDMA block. In addition, the carrier misalignment of the users due to their mobility and local oscillator imperfections can be brought into a tolerable range by an initial CFO compensation at the transmitter (i.e., sending the frequency shifted signal of each user at the uplink transmission based on its estimated and reported CFO). However, the residual CFOs of the users need to be compensated.

The currently known CFO compensation techniques can be categorized into two main groups; namely, time domain and frequency domain approaches. Time domain compensators mainly work based on a single user detector for each individual user which demands a separate discrete Fourier transform (DFT) unit per user. On the other hand, frequency domain techniques use a single DFT unit for all of the users which diminishes the complexity of the receiver.

Among frequency domain compensators, parallel and successive interference cancellation techniques are more popular, since their computational complexity is lower than other techniques. Although least square (LS) solutions and minimum mean square error (MMSE) solutions generally have better performance, they need inversion of a very large matrix, whose size is equal to the number of subcarriers, N. This can be as large as 2048 or 4096 subcarriers in WiMAX and 3GPP LTE standards. This requires iterative algorithms, where the MAI terms are generated and subtracted from the received signal in an iterative fashion. As a result, these techniques suffer from very high computational complexity. Furthermore, they cannot completely eliminate the MAI, even in high signal to noise ratios.

Accordingly, an object of the present invention is how to provide a carrier frequency offset compensation technique which overcomes at least one of the above mentioned problems associated with conventional techniques.

### SUMMARY

The present invention provides least squares and minimum mean square error methods for compensating for interference in a received signal due to multiple carrier frequency offsets in the uplink of an Orthogonal frequency division multiple access, OFDM, communication system which uses interleaved and block interleaved carrier assignment schemes, the method comprising the steps of:
performing a fast Fourier transform on the received signal; and
multiplying the transformed received signal by the inverse of the interference matrix to determine the compensated received signal; wherein the block circulant property of the interference matrix is used in the calculation of its inverse.

The invention provides two carrier frequency offset compensation techniques which are based on the least squares and minimum mean square error solutions, respectively. By utilizing the special block circulant property of an interference matrix, the present invention does not need to perform any iteration in order to calculate the compensated received signal. As a result, the computational complexity of the system is significantly reduced, thus enabling higher data rates and reduced memory requirements to be achieved, while at the same time maintaining the optimal performance of the OFDM system.

Preferably, the step of multiplying the transformed received signal by the inverse of the interference matrix comprises performing fast Fourier transform and inverse fast Fourier transform calculations together with one small matrix inversion and some additional complex multiplications.

In one embodiment, the fast Fourier transform and the inverse fast Fourier transform are calculated as part of a least square algorithm.

In another embodiment, the fast Fourier transform and the inverse fast Fourier transform are calculated as part of a minimum mean square error algorithm.

The least square algorithm may comprise the equation:

\hat{x}_{LS}=A^{H}D⁻¹A r̅
where X_{LS} is the compensated received signal,
the interference matrix, Λ=A^{H}DA,
the inverse of the interference matrix, Λ⁻¹=A^{H}D⁻¹A,
and wherein A is a block-DFT matrix, A^{H} is the block-IDFT matrix, D⁻¹ and D are block diagonal matrices, and ŕ is the received signal.

The minimum mean square error algorithm may comprise the equation:

\hat{x}_{MMSE}=A^{H} D̅⁻¹D^{H}A r̅
where X_{MMSE} is the compensated received signal,
the interference matrix, Λ=A^{H}DA,
the inverse of the interference matrix, Λ⁻¹=A^{H}D⁻¹A,
and wherein A is a block-DFT matrix, A^{H} is the block-IDFT matrix, D, D⁻¹ and D^{H} are block diagonal matrices, and ŕ is the received signal.

Preferably, At is calculated using L-point fast Fourier transforms and A^{H} is calculated using inverse fast Fourier transforms, wherein L=N/(KQ), N is the total number of subcarriers being used by all the users, K is the maximum number of users that can transmit their signals at the same time and Q is the number of subcarriers that the users are using in case of block interleaved carrier allocation In fact, in case of interleaved carrier allocation scheme Q=1.

The method may further comprise the initial step of removing the cyclic prefix of the received signal.

The present invention also provides a receiver for compensating for interference in a received signal due to carrier frequency offset in an uplink of an OFDMA communication system which uses interleaved and block interleaved carrier assignment schemes, the receiver comprising:
means for performing a discrete Fourier transform on the received signal; and
means for multiplying the transformed received signal by the inverse of the interference matrix to determine the compensated received signal; wherein the block circulant property of the interference matrix is used in the calculation of its inverse.

In one embodiment, the receiver comprises a base station operation in an OFDMA system.

Preferably, the means for multiplying the transformed received signal by the inverse of the interference matrix comprises means for performing fast Fourier transform and inverse fast Fourier transform calculations.

In one embodiment, the means for performing the fast Fourier transform and the inverse fast Fourier transform comprises a least square algorithm.

In another embodiment, the means for performing the fast Fourier transform and the inverse fast Fourier transform comprises a minimum mean square error algorithm.

There is also provided a computer program comprising program instructions for causing a computer program to carry out the above method which may be embodied on a record medium, carrier signal or read-only memory.

### BRIEF DESCRIPTION OF THE DRAWINGS

The invention will be more clearly understood from the following description of an embodiment thereof, given by way of example only, with reference to the accompanying drawings, in which:

FIG. 1 illustrates a block diagram of a Carrier Frequency Offset (CFO) compensation performed in a telecommunications system;

FIGS. 2 to 4 illustrates how the invention implements a CFO compensation scheme according to one embodiment of the invention; and

FIG. 5 shows the Normalized interference power between different subcarriers for block interleaved CAS where (a) shows the surface plot and (b) shows the contour plot of the interference.

### DETAILED DESCRIPTION OF THE DRAWINGS

As previously mentioned orthogonal frequency division multiple access (OFDMA) where different subcarriers are allocated to different users, has been adopted for the uplink of several standards and attracted very much attention as a result. Although OFDMA provides robustness against multipath fading channels, it is highly sensitive to carrier frequency offset (CFO) between transmitter and the receiver. OFDMA systems experience different carrier frequency offsets due to different users which destroys the orthogonality of the subcarriers. To compensate for the effect of multiple CFOs, the invention provides CFO compensation techniques applicable to interleaved and block interleaved carrier assignment schemes utilizing the special block circulant property of an interference matrix. This special structure of the matrix enables the method and system of the invention to factorize the matrix as multiplications of block DFT and IDFT matrices to a block diagonal matrix. Thus, in order to invert the interference matrix, the invention only needs to invert the small block matrices located on the main diagonal of the aforementioned block diagonal matrix. Due to the relationships described in more detail below, only the first block matrix needs to be inverted and the inverse of the rest are known factors of the first block matrix. Therefore, matrix inversion complexity as well as the complexity of its multiplication to the received signal at the base station which is passed through the N-point FFT block are dramatically reduced, thanks to the DFT and IDFT matrices that are present in the interference matrix factorization.

In contrast to the other sophisticated CFO compensation algorithms, the proposed solutions do not need any iteration. The system and method of the invention maintain the optimal performance. Thereby, the computational complexity of the detector will be dramatically reduced which reduces the processing time and consequently enables higher data rates while maintaining the optimal performance. The techniques do not only have lower computational complexity but they also have more robust performance in comparison with the current solutions.

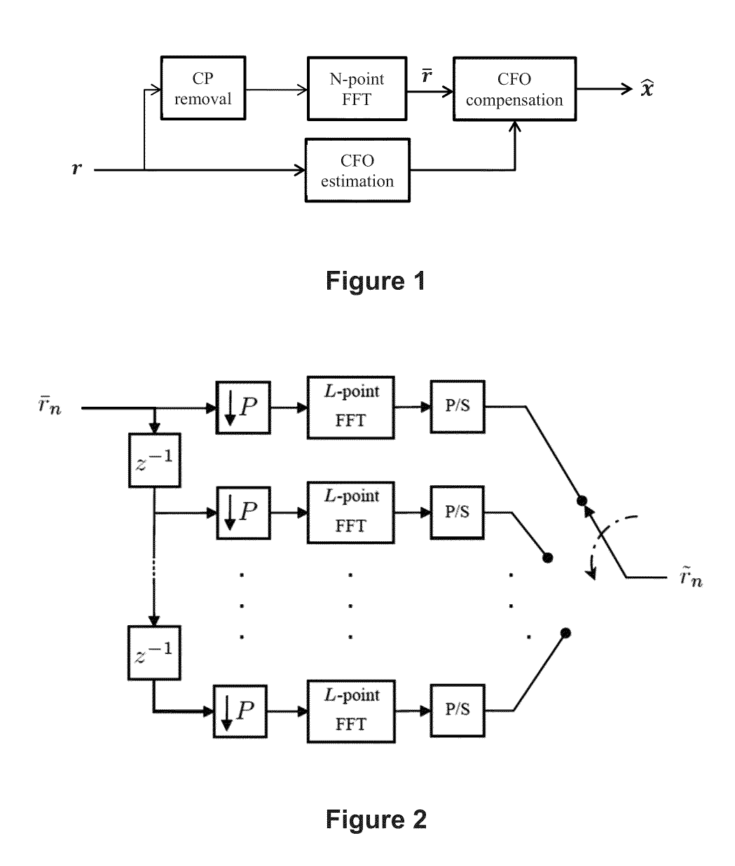

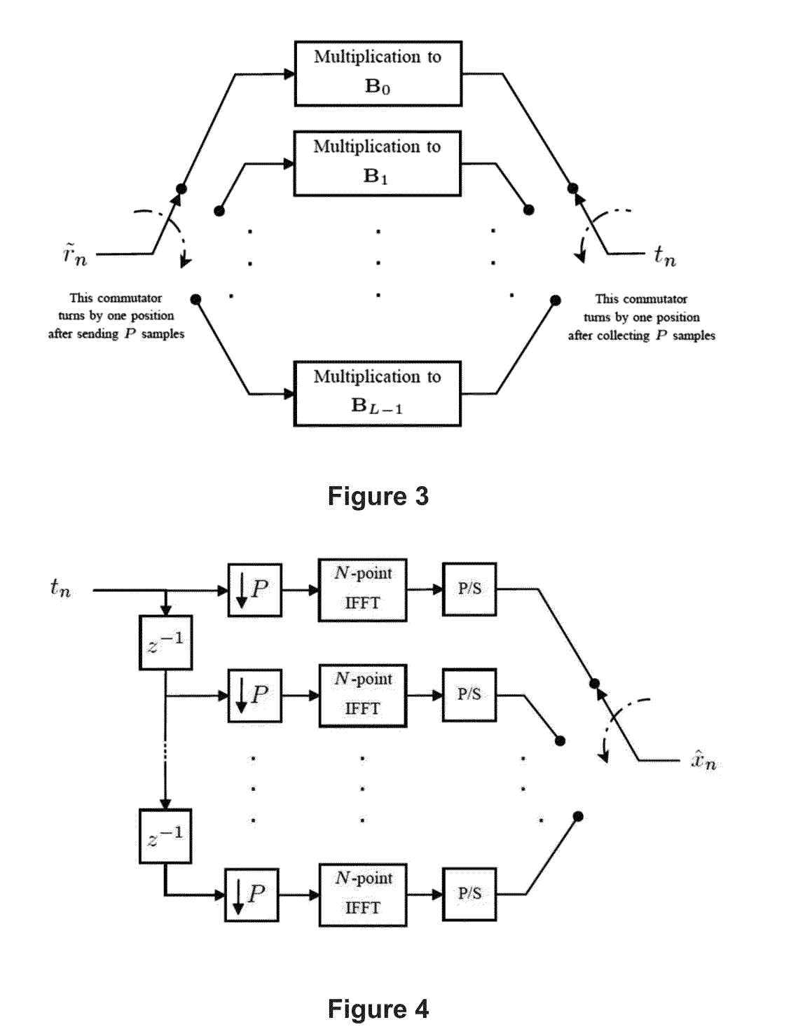

Referring now to FIG. 1 illustrates a block diagram of a Carrier Frequency Offset (CFO) compensation performed in a telecommunications system, for example at a base station. The invention implements a CFO compensation scheme by implementing one or more of the following steps:
1. FIG. 2 illustrates multiplication of a matrix A to the vector r̅ which can be implemented by using

$$L = \frac{N}{P}$$

number of FFT (fast courier transform) blocks where P=KQ is the down-sampling factor and P/S is the parallel to serial convertor which converts the parallel outputs of the FFT block to a serial stream. z⁻¹ is one sample time delay.
2. FIG. 3 illustrates multiplication of the resulting vector from A r̅ to the matrix D⁻¹ for the least squares solution or D̅⁻¹D^{H} for the minimum mean square error technique.
3. FIG. 4 illustrates multiplication of the matrix A^{H} to the resulting vector from step 2 which can be implemented by using L number of IFFT (inverse fast Fourier transform) blocks.

In FIGS. 2 to 4 the matrices Bᵢ are the i-th block matrices Dᵢ⁻¹ for the LS compensation technique and D̅ᵢ⁻¹Dᵢ^{H} for the MMSE technique. Dᵢ⁻¹ and D̅ᵢ⁻¹Dᵢ^{H} can be calculated based on the equations described below.

The received signal at the base station in the uplink of OFDMA based systems is the mixture of the signals of all the users that are sending their data streams simultaneously. As mentioned before, the timing misalignment of the users can be solved by using a long enough CP. However, the carrier misalignment of the users due to their mobility and local oscillator imperfections can be brought into a tolerable range by an initial CFO compensation at the transmitter (i.e., sending the frequency shifted signal of each user at the uplink transmission based on its estimated and reported CFO). Hence, the residual CFOs of the users need to be compensated. The received signal after CP removal and DFT block can be shown as the multiplication of the interference matrix to the signal affected by the multipath channel. Thus, the MAI and ICI caused by the interference matrix can be compensated by the multiplication of its inverse to the received signal after the DFT operation.

The invention provides a receiver and method for compensating for interference in a received signal due to carrier frequency offset in an uplink of an OFDM communication system which uses interleaved and block interleaved carrier assignment schemes. The receiver comprises a module or block for performing a discrete Fourier transform on the received signal. A module is configured for multiplying the transformed received signal by the inverse of the interference matrix to determine the compensated received signal. The block circulant property of the interference matrix is used in the calculation of its inverse.

A module for multiplying the transformed received signal by the inverse of the interference matrix comprises means for performing fast Fourier transform and inverse fast Fourier transform calculations using a least squares algorithm or a minimum mean squares error algorithm the operation of which is described in more detail below.

The present invention makes use of the fact that the interference matrix is block circulant in both interleaved and block interleaved carrier assignment schemes (I-CAS and BI-CAS). As a result, the computational complexity of the matrix inversion and multiplication process can be reduced dramatically by using fast Fourier transform (FFT) and inverse FFT (IFFT) algorithms.

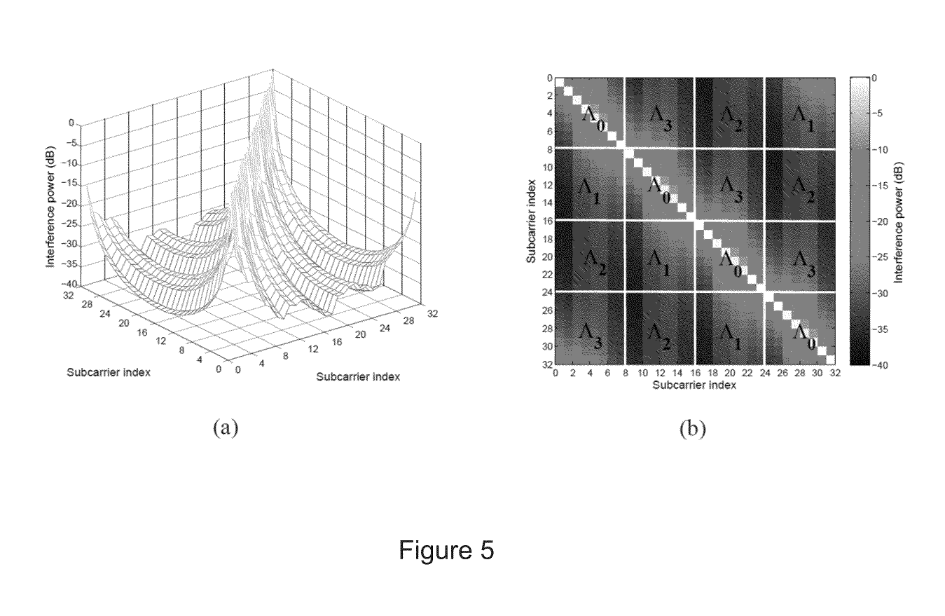

The block circulant property of the interference matrix is depicted in FIG. 5 for the case of having N=32 subcarriers in total and K=4 users with CFOs equal to ε₁=−0.15, ε₂=0.25, ε₃=−0.3, ε₄=0.2 (εᵢs are the normalized CFOs to the subcarrier spacing) using BI-CAS with Q=2 subcarriers per block. Needless to say, when Q=1, the BI-CAS reduces to the I-CAS. Thus, BI-CAS can be assumed as the generalized version of I-CAS.

Two embodiments of the invention will now be described. The first embodiment describes the use of fast Fourier transform and inverse fast Fourier transform algorithms as part of a least square solution for carrier frequency offset compensation in an OFDMA communication system which uses interleaved and block interleaved carrier assignment schemes, while the second embodiment describes the use of fast Fourier transform and inverse fast Fourier transform algorithms as part of a minimum mean square error solution for carrier frequency offset compensation.

In both embodiments, the uplink of an OFDMA system is assumed to have N number of subcarriers and K users. The data of distinct users are mapped onto mutually exclusive sets of subcarriers.

### 1. Least Squares Solution

An interference matrix, in I-CAS and BI-CAS cases, can be mathematically shown as:

$$Λ = ( \begin{matrix}{Λ}_{0} & {Λ}_{L - 1} & … & {Λ}_{1} \\ {Λ}_{1} & {Λ}_{0} & … & {Λ}_{2} \\ ⋮ & ⋮ & ⋱ & ⋮ \\ {Λ}_{L - 1} & {Λ}_{L - 2} & … & {Λ}_{0}\end{matrix} ) \qquad ( 1 )$$

Where Λᵢs are small sub-matrices of Λ and L is the number of blocks per user. Λᵢs are KQ by KQ matrices. K and Q are the number of users and subcarriers per block in BI-CAS, respectively. Due to the fact that the inverse of a block circulant matrix has the same property, the first block row or block column of the inverse matrix can only be generated and the rest of the matrix can be generated by circularly shifting the block rows or columns. Since, the matrix Λ is a block circulant matrix, it can be decomposed as

Λ=A^{H}DA (2)

where the matrix A is an N by N block-DFT matrix comprised of smaller KQ by KQ sub-matrices

$${Θ}_{m , n} = \frac{1}{\sqrt{L}} {e}^{( \frac{- j 2 π mn}{L} )} {I}_{KQ} \qquad ( 3 )$$

where m, n=0, . . . , L−1, Iₘ is identity matrix of size m by m and (·)^{H} is conjugate transpose operator. On the other hand, the matrix A^{H} is the block-IDFT matrix. The matrix D is a block-diagonal matrix.

D=Diag{D₀, . . . , D_{L-1}} (4)

The block-matrices of D on its main diagonal are of the size KQ by KQ, and due to the fact that the interference matrix is a block circulant matrix, the elements in the sub-matrices of D all have the same amplitude, and they are only different in phase. The block-matrices Dₗ can be mathematically depicted as:

$${[ {D}_{l} ]}_{m , n} = {e}^{\frac{j 2 π ( {ε}_{j} + n - m )}{N} ( ( - l ) ) L} {f}_{KQ} ( {ε}_{j} + n - m ) \qquad ( 5 )$$

where l=0, . . . , L−1, ((.))_{N} is modulo N operation and

$${f}_{N} ( x ) = \frac{sin ( π x )}{N sin ( \frac{π x}{N} )} {e}^{j π x ( 1 - \frac{1}{N} )} . \qquad ( 6 )$$

Hence, the block-matrices Dₗ are factors of each other and we have

Dₗ=Eₗ⊙D₀ (7)

where

$${[ {E}_{l} ]}_{m , n} = {e}^{\frac{j 2 π ( {ε}_{j} + n - m )}{N} ( L - l )} \qquad ( 8 )$$

l=0, . . . , L−1, m, n=0, . . . , KQ−1 and ⊙ shows the element-wise multiplication.

The matrix Λ⁻¹ can be found as

Λ⁻¹=A^{H}D⁻¹A (9)

where

D⁻¹=Diag{D₀⁻¹, . . . , D_{L-1}⁻¹}. (10)

Recalling (7), Dₗ⁻¹ matrices can be obtained as

Dₗ⁻¹=Eₗ^{H}⊙D₀⁻¹ (11)

Accordingly, the inversion of the matrix Λ, only needs a KQ by KQ matrix inversion. If the output of the DFT block at the receiver is the vector r̅, the least squares solution is

\hat{x}_{LS}=Λ⁻¹ r̅ (12)

Inserting (9) in (12), the following is obtained:

\hat{x}_{LS}=A^{H}D⁻¹A r̅ (13)

Since A is the block-DFT matrix, A r̅ can be efficiently calculated using L-point FFTs. Furthermore, due to the fact that D⁻¹ is a block-diagonal matrix, it will be appreciated that multiplication of it to the resulting vector from A r̅, has a low complexity. In the end, multiplication of A^{H} can be implemented efficiently using L-point IFFTs.

### 2. Minimum Mean Square Error Solution

The minimum mean square error solution can be shown as

x̅_{MMSE}=(II+σᵥ²I_{N})⁻¹Λ^{H} r̅ (14)

where II=Λ^{H}Λ and σᵥ² is the variance of additive white Gaussian noise (AWGN). Since the matrix Λ is a block circulant matrix, the multiplication of it by its conjugate transpose will keep the block circulant property. Therefore, it is possible to decompose (II+σᵥ²I_{N}) as

(II+σᵥ²I_{N})=A^{H} D̅A (15)

where

D̅=Diag{ D̅₀, . . . , D̅_{L-1}} (16)

The block-matrices of D̅ in its main diagonal are of the size KQ by KQ and the same as before, the block-matrices D̅ₗ are factors of each other and we have

D̅ₗ=Ēₗ⊙ D̅₀ (17)

Where

$${[ {\overline{E}}_{l} ]}_{m , n} = {e}^{\frac{j 2 π {ξ}_{nm}}{N} ( L - l )}$$

for l=0, . . . , L−1, m, n=0, . . . , KQ−1 and ξₙₘ=lᵢ−lᵢ+n−m.

It is worth mentioning that

D̅₀=D₀^{H}D₀+σᵥ²I_{KQ}

Finally,

(II+σᵥ²I_{N})⁻¹=A^{H} D̅⁻¹A (18)

and

D̅⁻¹=Diag{ D̅₀⁻¹, . . . , D̅_{L-1}⁻¹} (19)

Recalling (17), the following is obtained:

D̅ₗ⁻¹=Ēₗ^{H}⊙ D̅₀⁻¹ (20)

Thus, it is not necessary to invert all the block-matrices of D̅ in order to find its inverse. Rather, inversion of the first block matrix is sufficient, with the rest being derivable using equation (20).

Inserting (18) in (14) and using (2), the following is obtained

\hat{x}_{MMSE}=A^{H} D̅⁻¹D^{H}A r̅ (21)

In the same manner as for the least squared solution, A r̅ can be efficiently calculated using L-point FFTs. Again, the matrices D̅⁻¹ and D^{H} are block-diagonal matrices and their multiplication to the resulting vectors has low computational complexity. In the last stage, multiplication of A^{H} can be implemented with low complexity using L-point IFFTs.

It will be appreciated that the present invention provides numerous advantages over conventional CFO compensation techniques. Through the use the block circulant property of the interference matrix in LS and MMSE based solutions, the computational complexity of the system is significantly reduced, as iterative calculations are no longer necessary. Consequently, the technique enables higher data rates to be achieved, while maintaining optimal performance. This in turn reduces the processing time, and thus the memory requirements of the system are also reduced. Furthermore, due to this technique having a very low complexity, the implementation of the technique is also simpler than conventional techniques. This is very advantageous, especially for real time applications. In addition, this technique has also been shown to have more robust performance in comparison with conventional CFO compensation techniques.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a floppy disk or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A method for compensating for interference in a received signal due to multiple carrier frequency offsets in an uplink of an Orthogonal Frequency Division Multiple Access, OFDMA, communication system which uses interleaved and block interleaved carrier assignment schemes, the method comprising the steps of:
performing a discrete Fourier transform on the received signal; and
multiplying the transformed received signal by the inverse of an interference matrix to determine the compensated received signal; wherein the block circulant property of the interference matrix is used in the calculation of its inverse.

2. The method of claim 1 comprising the the step of multiplying the transformed received signal by the inverse of the interference matrix comprises performing KQ number of fast Fourier transforms, the same number od inverse fast Fourier transform calculations and multiplications to the inverse of a sparse matrix which is a block diagonal one and its inversion only needs inversion of a small KQ by KQ matrix.

3. The method of claim 1 wherein the step of multiplying the transformed received signal by the inverse of the interference matrix comprises performing KQ number of fast Fourier transforms, the same number od inverse fast Fourier transform calculations and multiplications to the inverse of a sparse matrix which is a block diagonal one and its inversion only needs inversion of a small KQ by KQ matrix.

4. The method of claim 3 wherein the fast Fourier transforms and the inverse fast Fourier transforms are calculated as part of a least square algorithm.

5. The method of claim 3 the fast Fourier transforms and the inverse fast Fourier transforms are calculated as part of a minimum mean square error algorithm.

6. The method of claim 1 wherein a fast Fourier transforms and an inverse fast Fourier transforms are calculated as part of a least square algorithm and the least square algorithm comprises the equation:
\hat{x}_{LS}=A^{H}D⁻¹A r̅
where X_{LS} is the compensated received signal,
the interference matrix, Λ=A^{H}DA,
the inverse of the interference matrix, Λ⁻¹=A^{H}D⁻¹A,
and wherein A is a block-DFT matrix, A^{H} is the block-IDFT matrix, D⁻¹ and D are block diagonal matrices, and ŕ is the received signal.

7. The method of claim 6 wherein the least square algorithm may comprise the equation:
\hat{x}_{LS}=A^{H}D⁻¹A r̅
where X_{LS} is the compensated received signal,
the interference matrix, Λ=A^{H}DA,
the inverse of the interference matrix, Λ⁻¹=A^{H}D⁻¹A,
and wherein A is a block-DFT matrix, A^{H} is the block-IDFT matrix, D⁻¹ and D are block diagonal matrices, and ŕ is the received signal.

8. The method of claim 1 wherein a fast Fourier transform and an inverse fast Fourier transform are calculated as part of a minimum mean square error algorithm may comprise the equation:
\hat{x}_{MMSE}=A^{H} D̅⁻¹D^{H}A r̅
where X_{MMSE} is the compensated received signal,
the interference matrix, Λ=A^{H}DA,
the inverse of the interference matrix, Λ⁻¹=A^{H}D⁻¹A,
and wherein A is a block-DFT matrix, A^{H} is the block-IDFT matrix, D, D⁻¹ and D^{H} are block diagonal matrices, and ŕ is the received signal.

9. The method of claim 8 wherein At is calculated using L-point fast Fourier transforms and A^{H} is calculated using inverse fast Fourier transforms, wherein L is the number of blocks per user of the OFDM system.

10. The method of claim 1 further comprises the initial step of removing the cyclic prefix of the received signal.

11. A system for compensating for interference in a received signal due to carrier frequency offset in an uplink of an OFDMA communication system which uses interleaved and block interleaved carrier assignment schemes, the system comprising:
a module for performing a discrete Fourier transform on the received signal; and
a module for multiplying the transformed received signal by the inverse of a matrix to determine the compensated received signal; wherein the block circulant property of the interference matrix is used in the calculation of its inverse.

12. The system of claim 11 comprising a module for multiplying the transformed received signal by the inverse of the interference matrix comprises means for performing fast Fourier transform and inverse fast Fourier transform calculations.

13. The system of claim 11 comprising a module for performing the fast Fourier transform and the inverse fast Fourier transform comprises a least square algorithm.

14. The system of claim 11 comprising a module for performing the fast Fourier transform and the inverse fast Fourier transform comprises a minimum mean square error algorithm.

15. A receiver for use in a base station comprising the system of claim 11.

16. A computer program comprising program instructions for causing a computer to perform a method for compensating for interference in a received signal due to carrier frequency offset in an uplink of an Orthogonal frequency division multiple access, OFDM, communication system which uses interleaved and block interleaved carrier assignment schemes, the method comprising the steps of:
performing a discrete Fourier transform on the received signal; and
multiplying the transformed received signal by the inverse of a matrix to determine the compensated received signal; wherein the block circulant property of the interference matrix is used in the calculation of its inverse.
